(19) United States
(12) Patent Application Publication
(10) Pub. No.: US 2026/0077354 A1
(43) Pub. Date: Mar. 19, 2026

(54) BIOMEDICAL DETECTION CHIP

(71) Applicant: National Tsing Hua University, Hsinchu City (TW)

(72) Inventors: Chun-You LAI, Hsinchu City (TW); Cheng-Hsien LIU, Hsinchu City (TW)

(21) Appl. No.: 18/911,030

(22) Filed: Oct. 9, 2024

(30) Foreign Application Priority Data
Sep. 13, 2024 (TW) 113134813

(51) Int. Cl. B01L 3/00

(52) U.S. Cl. CPC B01L 3/502753; B01L 2300/0645; B01L 2300/0819; B01L 2300/0867; B01L 2300/0883

(57) ABSTRACT

A biomedical detection chip includes a first detection module and a second detection module. The first detection module includes a first substrate and at least one first flowing channel unit including a first flowing channel in the first substrate, a first opening communicating with an end of the first flowing channel, a first chamber communicating with another end of the first flowing channel, and a second opening communicating with the first chamber. The second detection module, located under the first detection module, includes a second substrate and at least one second flowing channel including a second flowing channel in the second substrate, and third and fourth openings communicating with opposite ends of the second flowing channel. The second flowing channel includes a second chamber between third and fourth openings. The second opening corresponds to and communicates with the third opening, and the fourth opening is exposed from the first substrate.

### CROSS-REFERENCE TO RELATED APPLICATION

This application claims priority to Taiwanese Invention Patent Application No. 113134813, filed on Sep. 13, 2024, the entire disclosure of which is incorporated by reference herein.

### FIELD

The disclosure relates to a detection chip, and more particularly to a biomedical detection chip for cell detection.

### BACKGROUND

The development of modern technology brings convenience to people's lives. As people enjoy such convenience, the pace of people's lives is becoming increasingly greater, and with the stress from the society and the changes of eating habits due to the faster pace, many health issues have also emerged. Currently, the number of people diagnosed with cancer is climbing on a yearly basis. In addition to the previously believed genetic factors, daily lifestyle habits may also be a factor.

In recent years, the medical testing technology has been continuously advancing. In the past, the development of new therapeutic drugs relied on animal testing to observe the effectiveness and the side effects of a medication. However, such process is not only time-consuming and costly in terms of research and development expenses, but sometimes may also need to rely on past medical experiences of doctors for assessment. Currently, the emergence of the biomedical detection chips offers several advantages such as reduced testing doses, shorter testing time, avoidance of animal experiments, and the ability to simulate human organ cells. As a result, the biomedical detection chips have gradually replaced the traditional detecting method using animal or human subject.

However, most of the commercially available biomedical detection chips can only detect one type of organ cell at a time. To enable the doctors to have a more comprehensive understanding of potential situations before treating the patients for increasing the chances of recovery after treatment, there is a growing need for the development of biomedical detection chips that can simultaneously test multiple drugs or even detect various organ cells at once, thereby achieving the goal of personalized and precision medicine.

### SUMMARY

Therefore, an object of the disclosure is to provide a biomedical detection chip that can simultaneously detect multiple types of organ cells.

Thus, a biomedical detection chip of the present disclosure includes a first detection module and a second detection module.

The first detection module includes a first substrate and at least one first flowing channel unit which is formed in the first substrate.

The at least one first flowing channel unit includes a first flowing channel which is located in the first substrate, a first opening which extends downwardly from a surface of the first substrate and is in communication with an end of the first flowing channel, a first chamber which is located in the first substrate and is in communication with another end of the first flowing channel, and a second opening. The second opening extends downwardly from the surface of the first substrate, is located at a side of the first chamber opposite to the first flowing channel, and is in communication with the first chamber.

The second detection module is located under the first detection module, and includes a second substrate and at least one second flowing channel unit which corresponds in number with the at least one first flowing channel unit.

The at least one second flowing channel unit includes a second flowing channel which is located in the second substrate, and a third opening and a fourth opening which extend downwardly from a surface of the second substrate and are respectively in communication with opposite ends of the second flowing channel.

The second flowing channel includes a second chamber located between the third opening and the fourth opening. The second opening corresponds to and communicates with the third opening, and the fourth opening is exposed from the first substrate.

### BRIEF DESCRIPTION OF THE DRAWINGS

Other features and advantages of the disclosure will become apparent in the embodiment(s) with reference to the accompanying drawings, in which:

FIG. 1 is a perspective exploded view illustrating an embodiment of a biomedical detection chip according to the present disclosure;

FIG. 2 is a top view illustrating a first detection module of the embodiment;

FIG. 3 is a top view illustrating a second detection module of the embodiment;

FIG. 4 is a top view illustrating an electrode module of the embodiment; and

FIG. 5 is a top view illustrating a feeding module of the embodiment.

### DETAILED DESCRIPTION

Before the disclosure is described in greater detail, it should be noted that similar components are indicated by the same reference numbers in the following description.

Regarding the relevant technical content, features, and effects of this disclosure, they will be clearly presented in the detailed description of the embodiments with reference to the drawings. Additionally, it should be noted that the drawings of this disclosure merely indicates the structural and/or positional relationships among the components and are not related to the actual sizes of the individual components.

A biomedical detection chip of the present disclosure may be used for detecting organ cells, and particularly for simultaneously detecting and observing multiple types of organ cells.

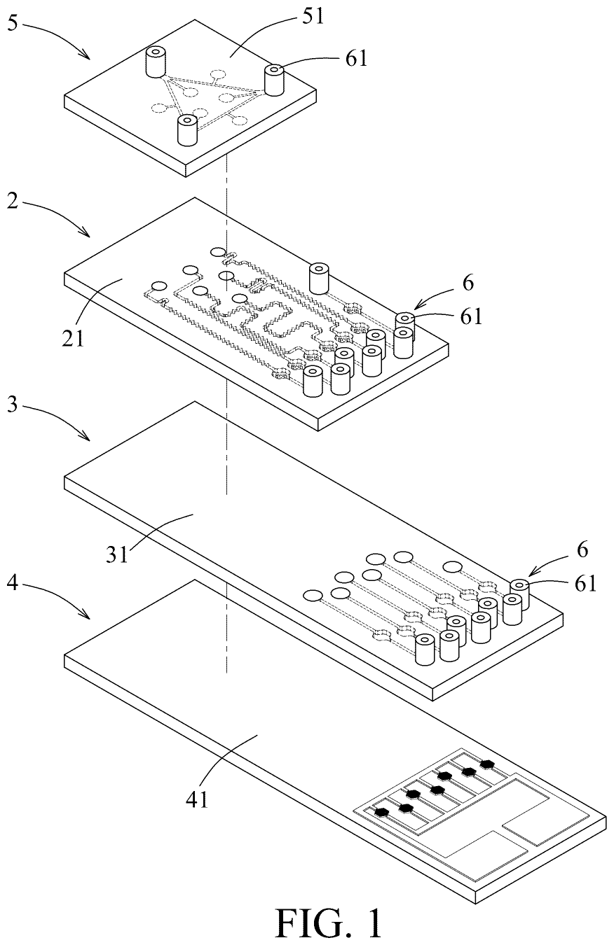

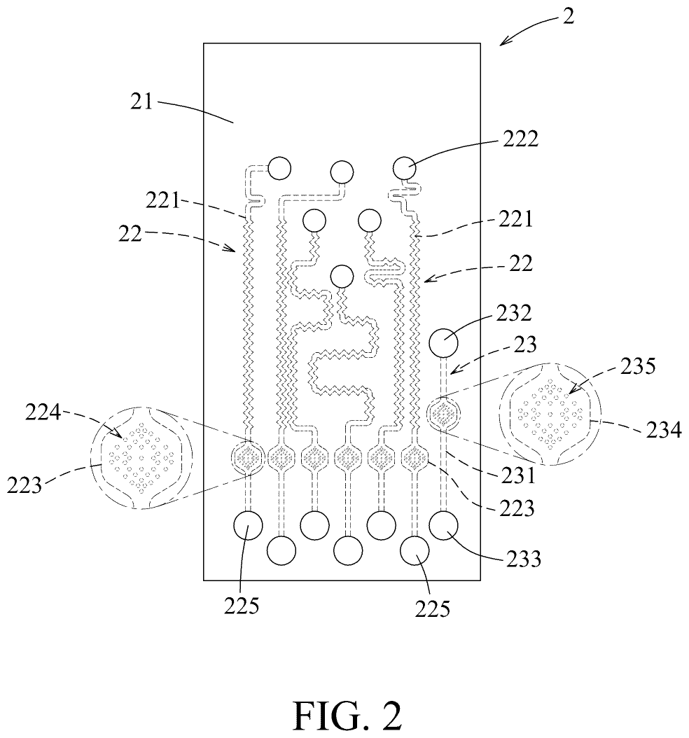

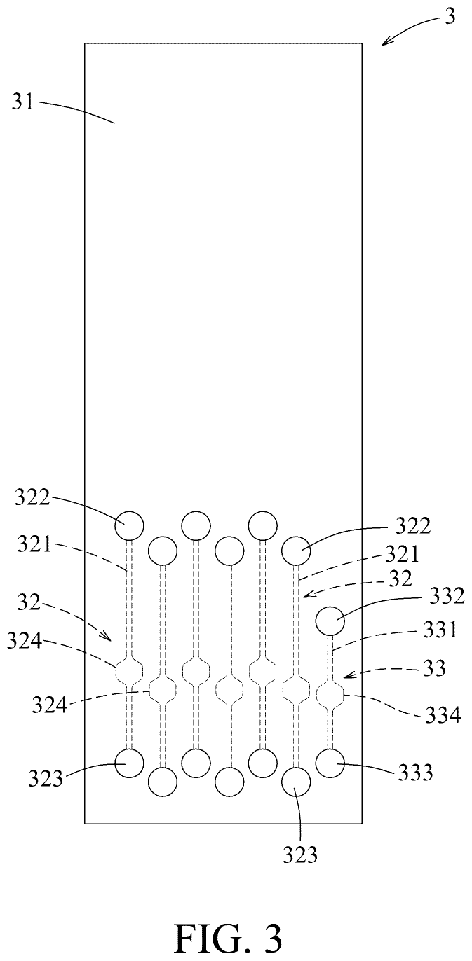

Referring to FIGS. 1 to 5, an embodiment of the biomedical detection chip of the present disclosure includes a first detection module 2, a second detection module 3, an electrode module 4, a feeding module 5, and a tube unit 6.

The first detection module 2 includes a first substrate 21, a plurality of first flowing channel units 22 which are formed in the first substrate 21, and a first reference channel unit 23.

Each of the first flowing channel units 22 includes a first flowing channel 221 which is located in the first substrate 21 and at least a part of which is in a zigzag structure, a first opening 222 which extends downwardly from a surface of the first substrate 21 and which is in communication with an end of the first flowing channel 221, a first chamber 223 which is located in the first substrate 21 and which is in communication with another end of the first flowing channel 221, and a second opening 225. The second opening 225 extends downwardly from the surface of the first substrate 21, is located at a side of the first chamber 223 opposite to the first flowing channel 221 and is in communication with the first chamber 223. Each of the first flowing channel units 22 may include a plurality of micropillars 224 which are disposed spaced apart from each other in the first chamber 223.

The first flowing channels 221 are same in length so that liquids flowing through the first flowing channels 221 may simultaneously reach the first chambers 223. In addition, by virtue of either the zigzag structure of the first flowing channels 221 or disposal of the micropillars 224 in the first chambers 223, a better mixing and dispersing effect of the liquids which flow through the first flowing channels 221 and enter the first chambers 223 may be achieved.

In some embodiments, a diameter of each of micropillars 224 ranges from 0.05 mm to 0.1 mm, so that a better dispersing effect may be provided without affecting mobility of the liquids.

In this embodiment, the diameter of each of the micropillars 224 is 0.05 mm, but is not limited thereto.

In some embodiments, the first flowing channels 221 may also be designed to be a smooth structure instead of the zigzag structure based on requirements. Moreover, in some embodiments, the micropillars 224 may not be provided in the first chambers 223 according to requirements.

The first reference channel unit 23 includes a first reference channel 231 which is located in the first substrate 21, and a first inlet 232 and a first outlet 233 each of which extends downwardly from the surface of the first substrate 21 and which are respectively in communication with the first reference channel 231. The first reference channel 231 has a first reference chamber 234 located between the first inlet 232 and the first outlet 233. The first reference channel unit 23 may further include a plurality of micropillars 235 which are disposed spaced apart from each other in the first reference chamber 234. The micropillars 235 and the micropillars 234 disposed in the first chambers 223 may be same in structure.

The second detection module 3 is located under the first detection module 2, and includes a second substrate 31 which is connected to the first substrate 21 and which is located below the first substrate 21, a plurality of second flowing channel units 32 which corresponds in number with the first flowing channel units 22, and a second reference channel unit 33.

Each of the second flowing channel units 32 includes a second flowing channel 321, which is located in the second substrate 31, and a third opening 322 and a fourth opening 323, which extend downwardly from a surface of second substrate 31 and which are respectively in communication with two opposite ends of the second flowing channel 321.

The second flowing channel 321 includes a second chamber 324 located between the third opening 322 and the fourth opening 323. The third opening 322 corresponds to and communicates with the second opening 225 of the corresponding first flowing channel 221. The fourth opening 323 is exposed from the first substrate 21 (that is to say, the fourth opening 323 is not covered by the first substrate 21).

The second reference channel unit 33 includes a second reference channel 331, which is located in the second substrate 31, and a second inlet 332 and a second outlet 333, which extend downwardly from the surface of the second substrate 31 and which are in communication with the second reference channel 331. The second reference channel 331 has a second reference chamber 334 located between the second inlet 332 and the second outlet 333. The first outlet 233 of the first reference channel 231 is in communication with the second inlet 332.

The tube unit 6 includes a plurality of tubes 61. The tubes 61 are respectively disposed corresponding to the second openings 225, the fourth openings 323 and a plurality of feeding ports 521 (to be described later), and extend upwardly. The tubes 61 are respectively in communication with the second openings 225, the fourth openings 323 and the feeding ports 52, for injecting or extracting liquids into or from the tubes 61.

The electrode module 4 is located under the second detection module 3, and includes an electrode carrier 41 which is connected to the second substrate 31 and is located below the second substrate 31, and a plurality of electrode units 42 which are formed on a surface of the electrode carrier 41 and which correspond to the second chambers 324. Each of the electrode units 42 includes a first electrode group 421 and a second electrode group 422, each of which is arranged in a predetermined pattern. The first electrode group 421 and the second electrode group 422 each form external electrical connection lines, thereby forming a first electrode circuit and a second electrode circuit. By virtue of the difference in electric field generated between the first electrode circuit and the second electrode circuit, the organ cells in the second chambers 324 may be uniformly distributed and arranged in a pattern corresponding to that of the electrode unit 42, thereby precisely evaluating the actual condition of the organ cells.

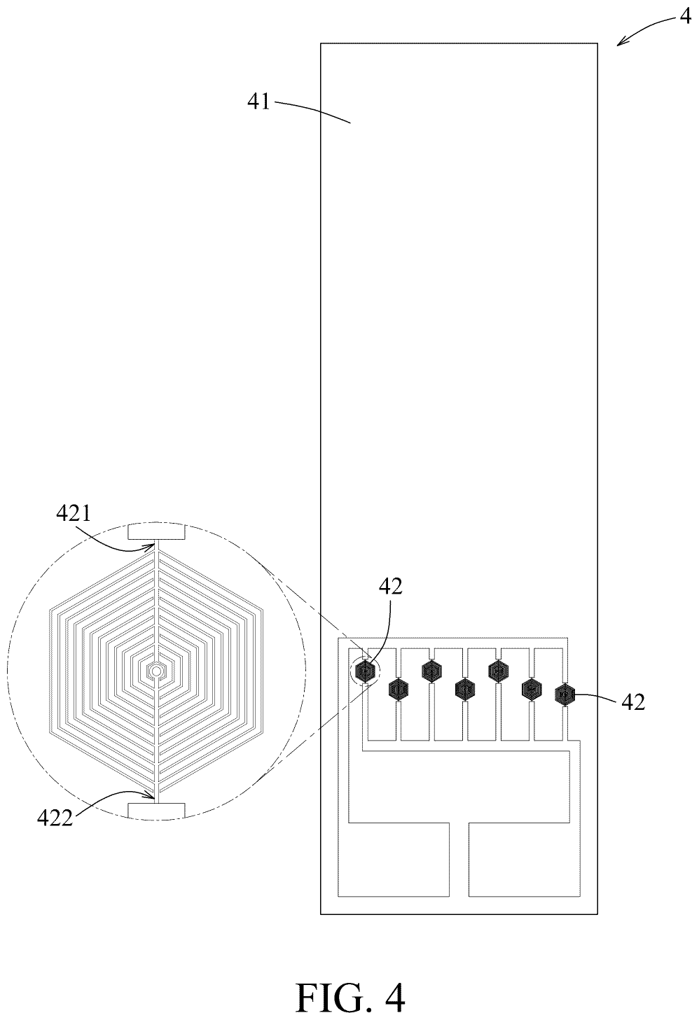

It should be noted that FIG. 4 shows an example that each of the first electrode group 421 and the second electrode group 422 of each of the electrode units 42 includes a plurality of sub-electrodes, and the sub-electrodes are arranged into a hexagonal pattern. However, in practice, the patterns of the first electrode group 421 and the second electrode group 422 may be adjusted according to requirements and is not limited hereto.

The feeding module 5 is located on the first detection module 2, and includes a feeding substrate 51 and a loading distribution unit 52.

The feeding substrate 51 is connected to the surface of the first substrate 21 and is located thereon. The feeding substrate 51 includes an upper surface and a lower surface and are opposite to each other.

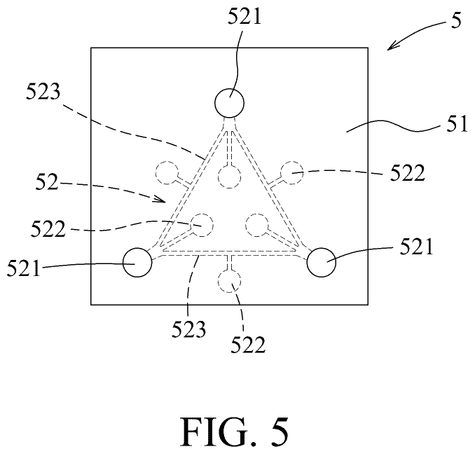

The loading distribution unit 52 includes a plurality of the feeding ports 521 which extend downwardly from the upper surface of the feeding substrate 51, a plurality of loading ports 522 which extend from the lower surface of the feeding substrate 51 toward the upper surface and which respectively correspond in position and communicates with the first openings 222, and a plurality of communication channels 523 which are located in the feeding substrate 51 and which correspondingly communicate with the feeding ports 521 and the loading ports 522. The second openings 225 are not covered by the feeding substrate 51. That is to say, the second openings 225 are exposed from the feeding substrate 51. In the embodiments of the present disclosure, the loading distribution unit 52 has three feeding ports 521 which are respectively located at the vertices of an imaginary triangle, three loading ports 522 which are respectively located outside three sides of the imaginary triangle, and three loading ports 522 which are located inside the imaginary triangle and opposite to the respective feeding ports 521. The communication channels 523 are used to communicate the feeding ports 521 and the loading ports 522. However, in actual practice, as long as the designs of the feeding ports 521, the loading ports 522, and the communication channels 523 allow different liquids entering from the feeding ports 521 to form mixtures with various mixing forms via the communication channels 523 and allow the mixtures to flow into the first detection module 2 from the corresponding loading ports 522, the configuration and the number thereof are not limited to those shown in FIG. 5.

In addition, it should be noted that the feeding substrate 51, the first substrate 21 and the second substrate 31 are stacked in a stepped manner in the present disclosure. The loading distribution unit 52, the first flowing channel units 22 and the second flowing channel units 32, which are respectively formed in the feeding substrate 52, the first substrate 21 and the second substrate 31, have height differences at connection nodes, so that bubbles generated during flowing of the liquids may be blocked at the connection nodes and not flow arbitrarily, thereby reducing the interference on subsequent flowing of the liquids or the influence on the detection results.

The first substrate 21, the second substrate 31 and the feeding substrate 51 may each be made of a soft silicone material with good biocompatibility.

When the biomedical detection chip of the present disclosure is used for detection of the multiple types of organ cells, the tubes 61 disposed on the fourth openings 323 may be blocked firstly, followed by injection of a first mixture which includes a light curable hydrogel and a first type of cells from the second openings 225 to distribute the first mixture in the first chambers 223. Then, the first mixture in the first chambers 223 is cured by a UV light so as to fix the first type of cells in the first chambers 223. The rest of the first mixture outside the first chambers 223 is washed by a buffer solution injected from the feeding ports 521 and is removed from the fourth openings 323, thereby accomplishing trapping of the first type of cells in the first chambers 223.

Then, the tubes 61 on the second openings 225 are blocked and a cell solution including a second type of cells is injected from the fourth openings 323. After the second type of cells is attached to the second chambers 324, excess of the second type of cells is washed by a buffer solution injected from the feeding ports 521. Then, a second mixture which includes a light curable hydrogel and a third type of cells is injected from the fourth openings 323 and flows into the second chambers 324. Then, the second mixture in the second chambers 324 is cured by the UV light, so that the second type of cells and the third type of cells are fixed in the second chambers 324. The rest of the second mixture is washed by a buffer solution injected from the feeding ports 521 and is removed from the fourth openings 323, thereby accomplishing trapping of cells in the second chambers 324.

The aforementioned hydrogel includes a bio-compatible polymer and a chemical compound used for light curing to crosslink with the polymers. Since a material and associated components of the hydrogel is well known to a person having ordinary skill in the art, detail descriptions thereof will not be provided herein.

After the cell trapping is accomplished, three drugs to be tested are injected from the three feeding ports 521, respectively. The drugs may be mixed and combined via the flowing channels 523, thereby forming six drugs with different combinations, which are then being injected into the first detection module 2 via the six loading ports 522 to accomplish injection of the drugs.

The drugs with the different combinations respectively flow from the first openings 222 through the first flowing channels 221, the first chambers 223 to the second openings 225 in sequence, and then flow through the third openings 322, the second flowing channels 321 and the second chambers 324 of the second detection module 3, thereby filling the drugs in the first detection module 2 and the second detection module 3 entirely.

During the detecting process, the drugs are continuously injected into the feeding port 521, and the liquids for the detection can be extracted from the tubes 61 on the second openings 225 and the fourth openings 323, thereby accomplishing a selection of combinations of drugs and simultaneous detection of multiple types of organ cells. When an operation is completed, all of the liquids may be discharged from the fourth openings 323.

In some embodiments, before injecting the cell solution including the second type of cells to the second chamber 324, the circuits of the first electrode groups 421 and the second electrode groups 422 of the electrode units 42 may be additionally connected, and by virtue of a difference in electric field generated between the first electrode circuit and the second electrode circuit, the organ cells in the second chambers 324 are distributed uniformly. In addition, a much precise result of the detection may be obtained by designing a predetermined pattern of the first electrode groups 421 and the second electrode groups 422. For example, as demonstrated in the embodiment, the first electrode groups 421 and the second electrode groups 422 may be designed to have electrode patterns each of which is arranged by a plurality of sub-electrodes each having a hexagonal shape, thereby bionically imitating the shape of a hepatic lobule of a liver. As a result, during the detecting process, liver cells may be arranged in the hexagonal pattern according to the electrode pattern and bionically imitate arrangement of the organ cells of a human body, thereby obtaining an even more precise result of the detection.

In some embodiments, the electrode module 4 and the feeding module 5 may be dispensed with as needed. A similar result may be obtained by a combination of the first detection module 2 and the second detection module 3.

In some embodiments, to confirm the extent to which of the combinations of drugs affect the organ cells in the first chambers 223 and the second chambers 324, trapping of the organ cells in the first reference channel unit 23 and the second reference channel unit 33 is performed according to the process as described above, so that the organ cells may serve as the control groups of the organ cells in the first flowing channel units 22 and the second flowing channel units 32.

It should be noted that the embodiments of the present disclosure are presented with the plurality of first flowing units 22 as examples. However, in actual practice, the number of the first flowing channel 221 may only be one. When the number of the first flowing channel 221 is one, the number of each of the first chamber 223, the first opening 222, and the second opening 225 is also one. Furthermore, the number of each of the second flowing channel unit 32, the electrode unit 42 and the tube 61 is also one, thereby also accomplishing the result of detecting multiple organ cells simultaneously.

In summary, by virtue of the first chamber 223 of the first detection module 2 and the second chamber 324 of the second detection module 3, in combination with the design of the loading distribution unit 52, the biomedical detection chip of the present disclosure may assess the effect of the different combinations of drugs on the different organ cells respectively captured in the first chamber 223 and the second chamber 324. Furthermore, by virtue of the substrates having the stepped design, the bubbles generated during the detecting process may not affect the result of the detection, thereby accomplishing the purpose of the present disclosure.

The above-mentioned embodiments are merely examples of this disclosure and should not be construed as limiting the scope of this disclosure. Any simple equivalent variations and modifications made in accordance with the claims and the content of the specification of this disclosure shall still fall within the scope of the patent covered by this disclosure.

What is claimed is:

1. A biomedical detection chip, comprising:
a first detection module, including
a first substrate, and
at least one first flowing channel unit which is formed in said first substrate, said at least one first flowing channel unit including a first flowing channel which is located in said first substrate, a first opening which extends downwardly from a surface of said first substrate and which is in communication with an end of said first flowing channel, a first chamber which is located in said first substrate and which is in communication with another end of said first flowing channel, and a second opening, said second opening extending downwardly from said surface of said first substrate, being located at a side of said first chamber opposite to said first flowing channel, and being in communication with said first chamber; and
a second detection module located under said first detection module, and including
a second substrate, and
at least one second flowing channel unit which corresponds in number with said at least one of first flowing channel unit, said at least one second flowing channel unit including a second flowing channel which is located in said second substrate, and a third opening and a fourth opening which extend downwardly from a surface of said second substrate and which are respectively in communication with opposite ends of said second flowing channel, wherein said second flowing channel includes a second chamber located between said third opening and said fourth opening, said second opening corresponds to and communicates with said third opening, and said fourth opening is exposed from said first substrate.

2. The biomedical detection chip according to claim 1, wherein said at least one first flowing channel unit includes a plurality of micropillars which are disposed in said first chamber.

3. The biomedical detection chip according to claim 2, wherein said plurality of micropillars are disposed spaced apart from each other.

4. The biomedical detection chip according to claim 1, wherein at least a portion of said first flowing channel has a zigzag structure.

5. The biomedical detection chip according to claim 1, further comprising a feeding module which is located on said first detection module, said feeding module including a feeding substrate and at least one feeding port which extends downwardly from a surface of said feeding substrate and which is in communication with said first opening, said second opening being exposed from said feeding substrate.

6. The biomedical detection chip according to claim 5, further comprising a tube unit, said tube unit including a plurality of tubes which correspond in position to said second opening, said fourth opening and said at least one feeding port, respectively, said tubes communicating respectively with said second opening, said fourth opening and said at least one feeding port.

7. The biomedical detection chip according to claim 1, further comprising an electrode module which is located below said second detection module, said electrode module including an electrode carrier and at least one electrode unit which is formed on a surface of said electrode carrier and which corresponds to said second chamber, said at least one electrode unit including a first electrode group and a second electrode group each of which is arranged in a predetermined pattern.

8. The biomedical detection chip according to claim 1, wherein said at least one first flowing channel unit includes a plurality of first flowing channel units, said at least one second flowing channel unit includes a plurality of second flowing channel units corresponding to said plurality of first flowing channel units, and said plurality of first flowing channels of said plurality of first flowing channel units are same in length.

9. The biomedical detection chip according to claim 8, further comprising a feeding module which is located on said first detection module, said feeding module including a feeding substrate and a loading distribution unit, said feeding substrate including an upper surface and a lower surface which are opposite to each other, said loading distribution unit including a plurality of feeding ports, a plurality of loading ports and a plurality of communication channels, said plurality of feeding ports extending downwardly from said upper surface of said feeding substrate, said plurality of loading ports extending from said lower surface of said feeding substrate toward said upper surface, and corresponding in position to and communicating with said first openings, respectively, said plurality of communication channels being located in said feeding substrate and in communication correspondingly with said plurality of feeding ports and said plurality of loading ports, said second openings of said plurality of first flowing channel units being exposed from said feeding substrate.

10. The biomedical detection chip according to claim 9, further comprising an electrode module which is located below said second detection module, said electrode module including an electrode carrier and a plurality of electrode units which are formed on a surface of said electrode carrier and which correspond to said second chambers of said plurality of second flowing channel units, each of said plurality of electrode units including a first electrode group and a second electrode group each of which is arranged in a predetermined pattern.

11. The biomedical detection chip according to claim 9, further comprising a tube unit, said tube unit including a plurality of tubes which correspond respectively in position to said second openings of said plurality of first flowing channel units, said fourth openings of said plurality of second flowing channel units and said plurality of feeding ports, and which is in communication respectively with said second openings, said fourth openings and said plurality of feeding ports.

12. The biomedical detection chip according to claim 1, wherein said first detection module further includes a first reference channel unit, said second detection module further including a second reference channel unit, said first reference channel unit including a first reference channel which is located in said first substrate, and a first inlet and a first outlet which extend downwardly from said surface of said first substrate and which are in communication with said first reference channel, said first reference channel having a first reference chamber located between said first inlet and said first outlet, said second reference channel unit including a second reference channel which is located in said second substrate, and a second inlet and a second outlet which extend downwardly from said surface of said second substrate and which are in communication with said second reference channel, said second reference channel having a second reference chamber located between said second inlet and said second outlet, said first outlet being in communication with said second inlet.

13. The biomedical detection chip according to claim 12, wherein said first reference channel unit includes a plurality of micropillars which are disposed in said first reference channel.

14. The biomedical detection chip according to claim 13, wherein said plurality of micropillars are disposed spaced apart from each other.
